(19) United States
(12) Patent Application Publication
(10) Pub. No.: US 2012/0316930 A1
(43) Pub. Date: Dec. 13, 2012

(54) INTEGRATED SYSTEM AND METHODS FOR TRACKING AND REPORTING CONSTRUCTION, COMPLETION, AND INSPECTION STATUS

(76) Inventor: William Clemenson, San Francisco, CA (US)

(21) Appl. No.: 13/492,903

(22) Filed: Jun. 10, 2012

Related U.S. Application Data
(60) Provisional application No. 61/495,810, filed on Jun. 10, 2011.

(51) Int. Cl. G06Q 10/06

(52) U.S. Cl. 705/7.39; 705/7.11

(57) ABSTRACT

Methods and systems for generating and displaying alerts are provided. An indication that each of a plurality of areas in a construction project is ready for one or more inspections by an inspector is received. For each of the plurality of areas, an inspection status is received from an inspector, wherein the inspection status identifies whether there were deficiencies associated with the area. For each subcontractor, an inspection success rate is calculated. The inspection success rate of each subcontractor is compared to a predetermined benchmark. A determination is made that the inspection success rate does not meet the predetermined benchmark. An alert is provided indicating that the inspection success rate of the respective subcontractor does not meet the predetermined benchmark.

### CROSS REFERENCE TO RELATED APPLICATIONS

This application claims the benefit under 35 U.S.C. §119(e) of U.S. Provisional Patent Application No. 61/495,810, entitled “INTEGRATED SYSTEM AND METHODS FOR TRACKING AND REPORTING CONSTRUCTION, COMPLETION, AND INSPECTION STATUS,” filed Jun. 10, 2011, which is incorporated herein by reference in its entirety.

### TECHNICAL FIELD

This disclosure relates generally to monitoring building construction and inspection.

### BACKGROUND

During construction of large complex construction projects, integrated comprehensive collaborative Quality Control (QC) processes are required to support regulatory agencies, owner construction oversight, general contractor oversight and subcontractor operations. In order to efficiently manage the construction process the general contractor and owner ideally would have up-to-the-minute status of every subcontractor, construction element, room and inspection. When information such as inspection, issue data and punch list data is delayed, the schedule impacts and associated costs accumulate.

### BRIEF SUMMARY

This disclosure describes methods, systems, and devices that can be used to provide construction and inspection alerts.

In a first general aspect, a computer-implemented method that includes receiving an indication that each of a plurality of areas in a construction project are ready for one or more inspections by an inspector. An area may be a room, indoor or outdoor area of a building, lobby, lounge, open space, indoor or outdoor wall, or any other defined space or portion of a building or manmade structure. Each area is associated with a subcontractor that has performed construction work on the area. An inspection status associated with each inspection of an area is received. The inspection status identifies whether there were deficiencies associated with the area. For each subcontractor, an inspection success rate is calculated based on the inspection status of each of the areas the respective subcontractor worked on. The inspection success rate of each subcontractor is compared to a predetermined benchmark. It is determined if the inspection success rate does not meet the predetermined benchmark. An alert indicating that the inspection success rate of the respective subcontractor does not meet the predetermined benchmark is provided for display.

Other embodiments of this aspect include corresponding systems, apparatus, and computer programs, configured to perform the actions of the methods, encoded on computer storage devices.

In another aspect, a computer-implemented method of providing digital content includes receiving an indication that each of a plurality of areas in a construction project are ready for one or more inspections by an inspector, wherein each area is associated with one or more subcontractors that has performed construction work on the area. For each of the plurality of areas, an inspection status associated with each inspection is received from the inspector that inspected the respective area. The inspection status identifies whether there were deficiencies associated with the area, wherein if an area is associated with one or more deficiencies, the area is associated with the subcontractor until it is ready for inspection again. An inspection duration is calculated for each inspection, wherein the inspection duration is a length of time from when the area inspection is first requested to when the area is associated with an inspection status indication indicating no deficiencies. An alert indicating that the inspection duration of the respective inspection exceeds an inspection duration benchmark is provided for display.

Other embodiments of this aspect include corresponding systems, apparatus, and computer programs, configured to perform the actions of the methods, encoded on computer storage devices.

Further embodiments, features, and advantages, as well as the structure and operation of the various embodiments are described in detail below with reference to accompanying drawings.

### BRIEF DESCRIPTION OF THE FIGURES

FIG. 1 illustrates a system for providing alerts

FIG. 2 is a flow diagram of an example process for providing alerts.

FIG. 3 is a flow diagram of another example process for providing alerts.

FIG. 4 is a diagram of an example computer device used to implement the system.

### DETAILED DESCRIPTION

A system will be described that provides accurate, real time collaboration for the various participants, enforced quality control timelines and timely status with easy to use interfaces such that multiple types and levels of professionals can monitor and manipulate specific information. The system is robust enough to enable the orchestration of complex professional organizations, streamlining their interactive processes in order to minimize task duration, down time and unnecessary.

In some implementations, an inspection monitoring process is provided that provides real-time collaboration, process tracking, quality control timing, and status reporting associated with a construction project. The process can include architectural plan ingestion, structural translation, database structure, inspectors & operators inputs/updates, quality control state definitions, report definitions, analysis tools, warnings & alerts interfaces and on-site interfaces.

In some implementations, a system is provided that can both detect positive trends and anticipate negative trends with subcontractors and/or inspectors such that management and owners can both reward excellence and actively mitigate declining trends in a timely manner. The system can provide a short feedback loop to enable the appropriate managing parties to react steer the construction project to successful completion.

Specific behavioral metrics can be observed, captured and analyzed in order to develop algorithms that reflect desirable, acceptable and unacceptable metrics, trends and behaviors.

Implementations below disclose specific metrics and algorithms that may be used to define desirable, acceptable and unacceptable indicators of project and vendor performance, including trends and behaviors, suited for projects such as when constructing large, complex buildings such as office towers, industrial facilities, schools, hospitals, airports and the like.

These metrics and techniques may also support the measurement of subcontractor and inspection performance data, anticipating trending based on an accumulation of information from multiple projects, project professionals and subcontractors. This facilitates determining adaptive thresholds and alerting for performance criteria when construction performance falls out of acceptable levels. The disclosed system provides interfaces and reports for use by inspectors, architects, owners, contractors, subcontractors and operators.

The system embeds real-time tracking overlaid with performance algorithms thereby harnessing the construction project with active performance metrics, reports and alerts that enable timely mitigating actions. By actively managing the construction project with real-time monitoring and analytics the construction process is streamlined, thereby saving schedule and cost.

Quality control can be a costly endeavor. Depending on the owners' risk mitigation desires versus cost sensitivities, quality control is sometimes reprioritized. Construction quality can be enhanced, construction costs can be reduced, conflicts can be minimized, and risks are lowered when lower cost quality control measures are put in place early on. By providing real-time metrics and analysis as described herein, all parties benefit from the increased visibility and awareness of their individual impact on the overall project progress.

The following sections describe the major functions of the system.

Architectural Plan Ingestion

Plans can enter the system in multiple formats, primarily in digital format. The digital representation of the construction/building plans are ingested into the Project Database on a per project basis. For example, the ingestion process comprises processing digitized architectural plans and, thereafter, the rooms and areas of the plans are interpreted, labeled, grouped and characterized. The results of the ingestion process are stored in a centralized database comprising the Project Database so as to identify each project from which the ingestion data was generated.

Database Structure

The database structure associates architectural plan elements, such as rooms and areas, as well as vendors, contractors, processes, inspections, status and the like, with the projects of the Project Database. On a parallel track, the architectural room list is imported into the centralized database by project, by building, by tower, by floor and by area.

Architectural Correlation

The ingested architectural plans are organized by drawing layers such that each layer can indicate different features or characteristics. Each room from the architectural room list is associated to the appropriate drawing layer. The physical locations of the rooms/areas are associated to database records that will ultimately be populated with the properties, status and history of the associated rooms/areas. Each database record also cross-references to the specific drawing representation of the specific room/area.

State Definitions

Construction process details are stored in the central database. As construction progresses, multiple inspections are requested at checkpoints. Inspectors, contractors, operators and subcontractors can change the state of a room or area based on an assignment, an action, or an observation. The state of the room/area is changed in the database and reflected in output reports and floor plan visualizations. Access for entering changes in state can be controlled by a project administrator, who can grant such change privileges to other persons.

The acceptable states that a room can transition between are configured at the beginning of the project based on multiple parameters such as user selection, room type, and area type. An example set of states that could be configured as “acceptable” are {Initial, InspectionRequestNew, InspectionRequestOpen, InspectionRequestReturned, InspectionRejected, InspectionClosed, InspectionIssue, InspectionPending}.

Data Collections

As inspections and work tasks are requested, assigned, filled, and closed, the construction and inspection history is recorded via time tagged logged entries including operator identification, state changes, and anecdotal data entry. The database can only be directly accessed by specifically designated System Administrators and specifically designated Users as controlled by project configurable permissions and security settings.

Inspectors and Operators Interfaces

The system is accessed through multiple interfaces with conditional access levels based on user log on, system type and executed function.

The following sections describe performance metrics and algorithms that are provided by the system.

### Construction Stages

Construction tasks begin with raw land and an idea. They progress from large earth movement, into strong foundations, through construction of complex weight bearing structures, to the middle ground of ducting, plumbing and electrical tasks, and on to the finishing tasks of ceilings, walls, outlets, & furnishings. All along the way managers, supervisors and inspectors validate the work for safety, regulatory compliance, architectural intent, functionality, quality and workmanship.

At multiple junctions, data concerning these inspections are captured along with a myriad of associated data. This collection of data provides the foundation for process control analysis and methods, which in turn enables all involved professionals to evaluate their work relative to a standard, to realize their direct impact on the project and to become aware when missteps are beginning to take a toll on the project. This gives the project stake holders an opportunity to take corrective action, minimizing cost and adverse schedule impacts.

Construction project schedules are utilized to manage thousands of tasks, hundreds of subcontractors and thousands of inspections. During the critical construction phases, the following system computes the following types of metrics, which can provide insight into actual completion rates, construction quality and subcontractor capabilities.

### Analysis Tools Framework

Inspection and subcontractor activities are the data samples of the construction process that are being observed and controlled by the general contractor. The database captures the life signs of the construction process itself by monitoring project vital signs such as inspection request duration rates, success rates, and subcontractor correction duration. With the collection of data from multiple projects, multiple subcontractors, multiple tasks and multiple inspectors into the centralized database, data mining and analytical methods can be employed in order to determine desirable vital signs that assist in the tracking and reporting of the project under consideration. In addition, the collected data can be suitably “anonymized” to ensure that only the database administrator is aware of the particular projects from which portions of the database were generated, and then the collected data can be used for analysis of additional projects and comparison of relative performance among the projects and the participants of the projects. Metrics and algorithms can be created that reflect the ‘very healthy’, ‘normal’, ‘unhealthy’, ‘crisis’ modes of project construction.

With a large enough data set, progress metrics can be developed to use as a benchmark for additional construction whether in the existing project or in new projects.

### Warnings and Alerts

Process control methods can be employed in order to characterize measurable metrics and compare expected behaviors vs. observed behaviors. When observed behaviors fall out of a predetermined acceptable behavioral variance, warnings and alerts are generated to notify selected users. The severity of the alert is determined based on selected criteria such as duration of abnormal state, variance of abnormal state, slope of trend, and length of time on trend.

### Subcontractor Performance

When a subcontractor performs poor quality work, inspections will result in a higher number of rejections than if the subcontractor is performing good quality work. Work that is the subject of a rejection must go into rework and are re-inspected, increasing the number of inspections required. It has been found that the number of inspection rejections is directly tied to the subcontractor capability, as is the number of inspections. By analyzing the number of rejections based on the area type, the task type, and the complexity level against previously measured subcontractor performances, metrics can be developed for performance judgment and an individual subcontractor performance quality rating. Thus, quantitative data is used in conjunction with prior performance history on a collective basis to define qualitative thresholds and ratings.

The impact of deficient subcontractor performance and vendor performance can have widespread adverse consequences throughout a project. When a subcontractor is overloaded or understaffed, his overall production rate is impacted. The duration from the time that an inspection cycle begins to the time of completion lengthens. Additionally, when an inspection fails, the rework time duration is also lengthened. Construction schedule is not only impacted by the subcontractor's work quality, but their work timeliness as well. The duration between inspection rejection and new inspection request is affected by both the complexity of the problem and the staffing level of the subcontractor. The first affects quality, while both affect schedule.

### Inspection Performance Data and Measurements

The system captures performance data during all phases of the construction project. During project setup many information fields are prepared in anticipation of data measurements that are to be performed. These include the definition or identification of subcontractors by company identifier and type of work; locations in a project floor plan are defined by section, area, room; areas are defined by type, location and square footage; systems are labeled by type, etc.

Data capture during project performance can be described according to different phases or actions that occur during the project, as described next. Collection of these data items can occur via user input, such as by computers, mobile data entry devices and workstations. Collection of data may also occur by network communications for receipt of data, reading of data from physical media, or by any other means suitable for receiving data in a usable format.

Project Start indicates a timestamp date and time at start of project. At project startup, all architectural drawings, such as via digitized architectural plans are ingested. All building(s), floor(s), tower(s), area(s), room(s) are created for the project. Drawn floor plans are associated with specific room and area maps. All architectural references are included. All data created by the ingestion process, user input and operations described herein are stored in a centralized database comprising the Project Database so as to identify each project from which the data was generated.

Location Reference Drawing associations are made. Example associations include Floor Plan A.01.5, Floor Plan (Name, ID, Description, FileName, CheckInStatus, VersionID); and associated location (level (Name & ID), tower (Name & ID), building (Name & ID), project ID. The following assignments may also be made:

For each location, assign location type such as room, area, stairs, elevator.
For each entered room, assign unique room identifier and define room type.
For each entered area, assign unique area identifier and define area type.
For each entered system, assign unique system identifier and define system type.

The data assignments described above can occur automatically, as where the system determines the next assignment number to be used for a data item as data items for a project are processed, or data assignments may be given values by user input. Once the project setup is complete and work has commenced, the following sections describe the inspection data that is collected.

Each Inspection Request Creation:
Timestamp: Date and Time
Project ID:=project unique identifier
User Information:=Requestor's (group ID, subcontractor ID, user ID)
CurrentStatusID:=initialize
Requestor: e.g. {plumbing subcontractor B, electrical subcontractor F}
Inspection Request Number: unique identifier for this inspection
Inspection Request Version: initialize

Inspection Type, e.g. {Foundation, In Wall Closure, Framing, Plumbing, MedGas, MechPipe}
Specification Section—E.G. 01 42 00 References
OSHPD Permit ID, if applicable
Inspection Location—associate Building (Name & ID), Tower (Name & ID), Level (Name & ID), Area (Name & ID), Room (Name & ID), Type (Name & ID) {e.g. overhead, tel.Data, Nurse Call, Plumbing, HVAC, Fire protection}
Inspection Status—e.g. {New, Open, Issue, Closed, Returned, Rejected, Cancelled, ReturnedAck, RejectAck, ReInspect}
Inspection Notes—Anecdotal Text.

Each Inspection Request Modification by Inspection Number:
Timestamp: Date and Time
Modification Requestor: e.g. {plumbing subcontractor B, electrical subcontractor F, inspector J, general contractor A}
Inspection Version Increment
Inspection Status—e.g. {New, Open, Issue, Closed, Returned, Rejected, Cancelled, ReturnedAck, RejectAck, ReInspect}
Inspection Notes—Anecdotal Text.

Each Inspection Closed:
Timestamp: Date & Time
Inspection Identifier Unique identifying number per inspection
Inspection Version Increment
Closer: e.g. {General Contractor A, Electrical Subcontractor G}
Inspection Notes Anecdotal Text

### Performance Metrics

Multiple metrics can be calculated and depicted in a graphical representation. For example, the rate of inspection requests, closures, re-inspections and cancellations, as well as performance by subcontractor and by inspection type can all be evaluated and judged based on historical performance measurements. The graphical representation can utilize a variety of data visualization techniques and can comprise bar charts, pie charts, x-y plots, depiction of solids, three-dimensional representations and the like.

Performance metrics are calculated across a very large set of data in order to create conforming graphs with strong statistical likelihood. These metrics and graphs are sorted, calculated, and analyzed across multiple dimensions including {total project, subcontractor type, inspection type, inspection duration}.

Metrics such as performance rates and changes in rates are calculated and compared to a determined compliance envelope. The following metrics are used to create representative behavioral models across the multiple dimensions.

Inspection Duration

Duration of an Individual Inspection is defined as:

D=TimeStamp(Closed)−TimeStamp(New);

wherein repetitious inspections due to rejection are included between “New” and “Closed”. For example, if a request for inspection is initiated on Jul. 7, 2007 at 7 am, is inspected and rejected, fixed, re-inspected, rejected again, fixed again, and is finally successfully closed on Oct. 10, 2007 at 7 am, the duration is 95 days (2280 hours).

Inspection Area

Area of an Individual Inspection is defined as:

A=square footage of inspected workmanship.

For example, if a request for inspection is requested on the overhead ceiling panels covers a section of a building that is 100 ft×300 ft, the area of the inspection is 30,000 sq ft.

Subcontractor Success Rate

It has been found that an overall performance metric is useful for high-level comparison of vendor and subcontractor performance. The system provides a useful overall performance metric referred to as percent success rate. The percent success rate of an Individual Subcontractor is defined as:

$$S ( sub ) = 100 * \frac{{\sum }_{1}^{n} {I}_{suc} ( sub )}{{\sum }_{1}^{n} ( {I}_{rej} ( sub ) + {I}_{suc} ( sub ) )} ;$$

wherein I_{suc}(sub)—Successful Inspection on task performed by Subcontractor ‘sub’; Iᵣₑⱼ(sub)=Rejected Inspection on task performed by Subcontractor ‘sub’; and n=Number of Inspection completed on tasks performed by Subcontractor ‘sub’.

Subcontractor Rejection Rate

The system defines percent rejection rate of an Individual Subcontractor as:

$$R ( sub ) = 100 * ( 1 - \frac{{\sum }_{1}^{n} {I}_{suc} ( sub )}{{\sum }_{1}^{n} ( {I}_{rej} ( sub ) + {I}_{suc} ( sub ) )} )$$

Subcontractor Type Metrics

It has been found that different subcontractor types statistically have different success factors and different success rate profiles. Therefore, the dataset is analyzed by subcontractor type in order to create expectations, profiles, envelopes, and thresholds.

Subcontractor Type Performance Quality Metric 1

The system defines Subcontractor Type Performance Quality Metric 1 (STPQ_M1) of all subcontractors of a particular subcontractor type (subtype) as:

$$STPQ\_M 1 ( subtype ) = S ( subtype ) * \frac{{\sum }_{1}^{p} A}{{\sum }_{1}^{p} D} ;$$

wherein p=the number of inspections completed on tasks performed by all subcontractors of type ‘subtype’. Examples of Subcontractor subtypes are concrete, electrical, plumbing, and HVAC.

Subcontractor Type Performance Quality Metric 2

The system defines Subcontractor Type Performance Quality Metric 2 (STPQ_M2) of all subcontractors of a particular type (subtype) as:

$$STPQ\_M2 ( subtype ) = S ( subtype ) * {\sum }_{1}^{p} \frac{A}{D} .$$

### Performance Factors

In order to create performance envelopes between subcontractor types, project types, inspection types and room types; the system defines the following factors.

Subcontractor Type Performance Factor

Based on historical data across one or more projects, subcontractor type normalization is calculated, thus enabling comparison of subcontractor performance across subcontractor type boundaries. A look up table is generated based on accumulated data. Different subcontractors may have different normalized success rates. Subcontractor type may be represented by term K(subtype) in the metric equations below.

Project Type Performance Factor

Based on historical data across multiple projects, project type normalization is calculated, thus enabling comparison of project performance across project type boundaries. A look up table is generated based on accumulated data. Example project types are hospital, airport, resort, etc., represented by L(projtype).

Inspection Type Performance Factor

Based on historical data across multiple projects, inspection type normalization is calculated, thus enabling comparison of performance across inspection type boundaries. A look up table is generated based on accumulated data. An example inspection types is in-wall. Inspection types may be represented by M(insptype).

Room Type Performance Factor

Based on historical data across multiple projects, room type normalization is calculated, thus enabling comparison of performance across room type boundaries. A look up table is generated based on accumulated data. Room types may include ICU, Med Surg, etc. Room type may be represented by N(roomtype).

### Subcontractor Performance Metrics

Each subcontractor has an individual success factor and individual success rate profile. Therefore, the dataset is analyzed by subcontractor in order to measure performance quality. The system defines the following subcontractor performance metrics.

Subcontractor Performance Quality Metric 1

The Subcontractor Performance Quality (SPQ) of a particular subcontractor (sub) is defined as:

$$SPQ\_M1 ( sub ) = K ( subtype ) * S ( sub ) * \frac{{\sum }_{1}^{n} A}{{\sum }_{1}^{n} D} ;$$

wherein n=Number of Inspections completed on tasks performed by Subcontractor ‘sub’.

Subcontractor Performance Quality Metric 2

The Subcontractor Performance Quality (SPQ) of a particular subcontractor (sub) is defined as:

$$SPQ\_M2 ( sub ) = K ( subtype ) * S ( sub ) * {\sum }_{1}^{n} \frac{A}{D} .$$

### Overall Project Performance Metrics

The project will have and overall success factor based on all the inspections of all the tasks. Therefore, the dataset is accumulated by tasks in order to create measure performance quality.

Overall Performance Quality Metric 1

The Overall Performance Quality Metric 1 (OPQ_M1) of a project is defined as:

$$OPQ\_M1 ( proj ) = L ( projtype ) * S ( sub ) * \frac{{\sum }_{1}^{p} A}{{\sum }_{1}^{p} D} ;$$

wherein p=Number of Inspections completed on tasks performed by all parties in project.

Overall Performance Quality Metric 2

The Overall Performance Quality Metric 2 (OPQ_M2) of a project is defined as:

$$OPQ\_M2 ( proj ) = L ( projtype ) * S ( sub ) * {\sum }_{1}^{p} \frac{A}{D} .$$

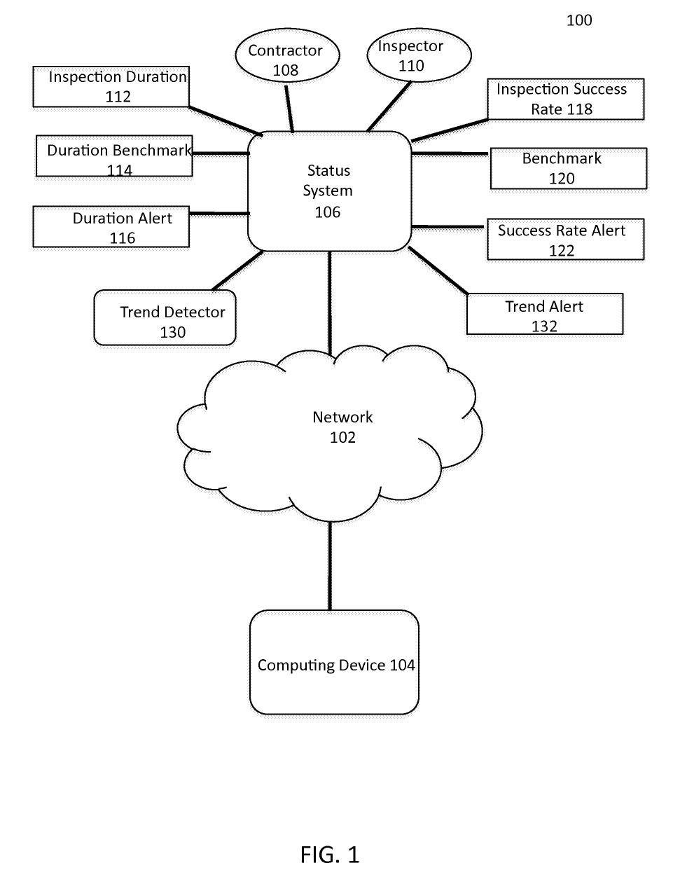

FIG. 1 illustrates an example 100. System 100 includes network 102 and computing device 104. A computing device can be any type of computing device having one or more processors. For example, a computing device can be a computer, server, workstation, mobile device (e.g., a mobile phone, personal digital assistant, navigation device, tablet, laptop or any other user carried device), game console, set-top box, kiosk, embedded system or other device having at least one processor and memory. A computing device may include a communication port or I/O device for communicating over wired or wireless communication link(s).

Network 102 may be any network or combination of networks that can carry data communications. Such a network 102 may include, but is not limited to, a local area network, metropolitan area network, and/or wide area network such as the Internet. Network 102 can support protocols and technology including, but not limited to, World Wide Web (or simply the “Web”), protocols such as a Hypertext Transfer Protocol (“HTTP”) protocols, and/or services. Intermediate web servers, gateways, or other servers may be provided between components of the system shown in FIG. 1, depending upon a particular application or environment.

System 100 includes a status system 106 that is used to send alerts during construction phases of various construction projects. Once a construction project reaches a predetermined phase, one or more rooms in the project may be ready for inspection by an inspector 110. One or more subcontractors may have performed work on each room. For example, an electrical subcontractor may have completed electrical work. A mechanical subcontractor may have completed mechanical work. Once their work is completed on a room, the owner or general contractor 108 may request an inspection of the work a subcontractor performed. In system 106, the status of each inspection is set to “open” indicating that the inspection is ready for the inspector.

An inspector 110 may inspect the room and determine if any deficiencies exist with the room. If there are one or more deficiencies, these are noted in system 106. The status of the inspection remains open. The subcontractor associated with the inspection must again complete work on the deficiencies and the room is inspected again. If there are no deficiencies, the status of the inspection is changed to “closed” in system 106.

System 106 determines a length of time that each inspection remains “open.” This is the inspection duration 112. If the inspection duration takes longer than a duration benchmark 114, a duration alert 116 is sent by system 106.

System 106 also measures an inspection success rate 118 associated with each subcontractor. Each subcontractor may be associated with a number of inspections. For example, each subcontractor may have worked on many rooms on a project. Each inspection is analyzed to determine how many were marked “closed” and how many had deficiencies. The inspection success rate 118 is compared to a benchmark 120 the inspection success rate 118 falls below the benchmark, a success rate alert 122 is sent by system 106.

Benchmarks may be predetermined or adapted based on feedback from the same or other projects. Benchmarks may also be normalized, as discussed above for performance factors, including according to project type, subcontractor type, inspection type, room type, etc.

In some implementations, behaviors may be monitored and tracked. Alerts may be generated and provided for display based on behavior benchmarks or patterns established by contractor 108.

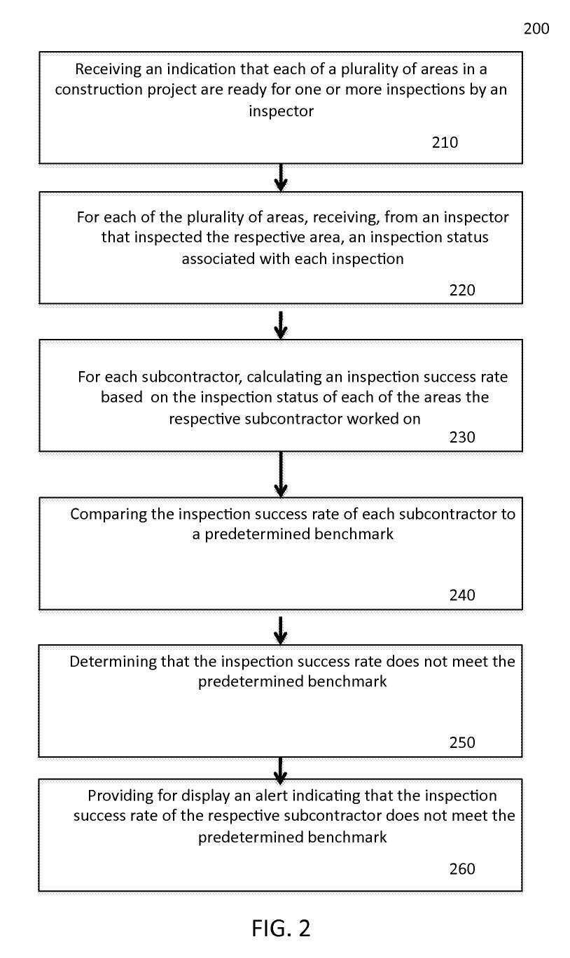

FIG. 2 is a flowchart illustrating an example method 200 for of providing an alert. In some implementations, actions represented in the flowchart may be performed by status system 106 included in the system 100 as shown in FIG. 1.

At stage 210, an indication is received that each of a plurality of areas in a construction project are ready for one or more inspections by an inspector. Each area is associated with a subcontractor that has performed construction work on the area. One subcontractor may have performed work on one or more areas within a project.

At stage 220, for each of the plurality of areas, an inspection status associated with each inspection is received from an inspector. The inspection status identifies whether there were deficiencies associated with the area.

At stage 230, for each subcontractor, an inspection success rate is calculated based on the inspection status of each of the areas the respective subcontractor worked on. The inspection success rate measures how successful a subcontractor is in finishing a construction phase without any deficiencies being associated with the area on which they worked. These calculations may be based on a number of inspections having no deficiencies and a number of inspections having one or more deficiencies. As described above, project type, inspection area and inspection duration may also be factors in calculating and comparing success rates.

At stage 240, the inspection success rate of each subcontractor is compared to a predetermined benchmark. The predetermined benchmark may be one selected by the contractor. In some implementations, it may be one that is based on industry standards. Benchmarks and calculations may be normalized based on a type of inspection, as described above.

At stage 250, a determination is made that the inspection success rate does not meet the predetermined benchmark. For example, the inspection success rate may be below the benchmark.

At stage 260, an alert is provided indicating that the inspection success rate of the respective subcontractor does not meet the predetermined benchmark. The alert can be displayed on a computing device 104. The alert may also be emailed to a user of system 106, such as contractor 108, inspector 110 or a subcontractor. The alert may based on a severity of the success rate or duration discrepancy.

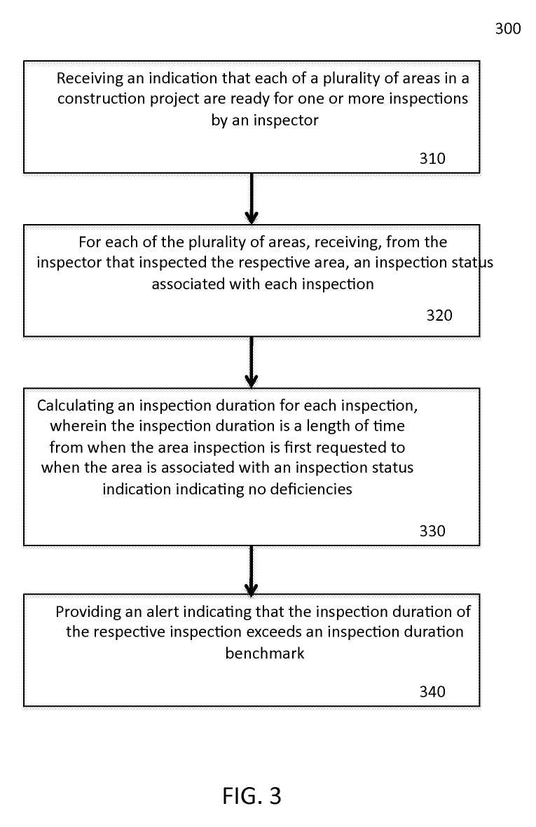

FIG. 3 is a flowchart illustrating an example method 300 for of providing an alert. In some implementations, actions represented in the flowchart may be performed by status system 106 included in the system 100 as shown in FIG. 1.

At stage 310, an indication is received that each of a plurality of areas in a construction project are ready for one or more inspections by an inspector. Each area is associated with one or more subcontractors that have performed construction work on the area.

At stage 320, for each of the plurality of areas, an inspection status associated with each inspection is received from the inspector that inspected the respective area. The inspection status identifies whether there were deficiencies associated with the area. If an area is associated with one or more deficiencies, the area is associated with the subcontractor until it is ready for inspection again.

At stage 330, inspection duration for each inspection is calculated, wherein the inspection duration is a length of time from when the area inspection is first requested to when the area is associated with an inspection status indication indicating no deficiencies, or that the inspection is closed.

At stage 340, an alert is provided indicating that the inspection duration of the respective inspection exceeds an inspection duration benchmark.

### Trends

Subcontractor success rates, inspection durations and other performance metrics may improve or degrade. It is important to have the ability to recognize subcontractors who are maintaining a high performance rate or are improving their performance. Information about which subcontractors are showing a positive trend may also assist in planning and allocation of project management resources. It is also important to have the ability to detect negative trends in order to anticipate future issues so that they can be addressed or mitigated sooner. When thousands of inspections are involved, such alerts need to be automated and provided in real-time.

In an implementation, system 106 may include trend detector 130 that is configured to detect both positive and negative trends. System 106 calculates an inspection success rate or inspection duration for each subcontractor and compares it to previous success rates or durations of the subcontractor. Trend alerts 132 can be generated based on the results of this comparison.

Positive trends alerts may be generated. For example, a subcontractor who has in the past performed at a success rate of 85% may be close to a benchmark of 90% but not quite at the acceptable level. However, if the success rate has recently been 87% and 89%, a positive alert can be provided to help an owner or general subcontractor know to encourage the subcontractor to exceed the benchmark of 90%.

Negative trend alerts may also be generated. For example, if a subcontractor who barely meets a target benchmark starts to drop in performance, an alert can be provided in order to anticipate possible issues with the subcontractor. Alerts can also watch for subcontractors falling further below a benchmark. An early alert can help focus attention on addressing or mitigating issues before a subcontractor impacts the schedule or before the effects of subpar performance accumulate.

Various alerts may be generated based on a severity of a trend. A chronological series of past and current success rates or durations, if viewed graphically on a timeline, may form a slope. The slope may be small or it may be steep. A steeper slope could generate an alert differentiated from other alerts due to its severity.

Other factors may be considered in the severity of an alert. The length or duration of a period of unacceptable performance may contribute to a severity of an alert, whether the unacceptable performance is temporary or becoming systemic. The variance of such metrics may illustrate a trend or an unpredictable and erratic pattern. The length of time of a trend may also contribute to the severity of an alert. Just as benchmarks may be normalized based on a type of metric, trends may also be normalized based on a subcontractor type, inspection type, area type, etc.

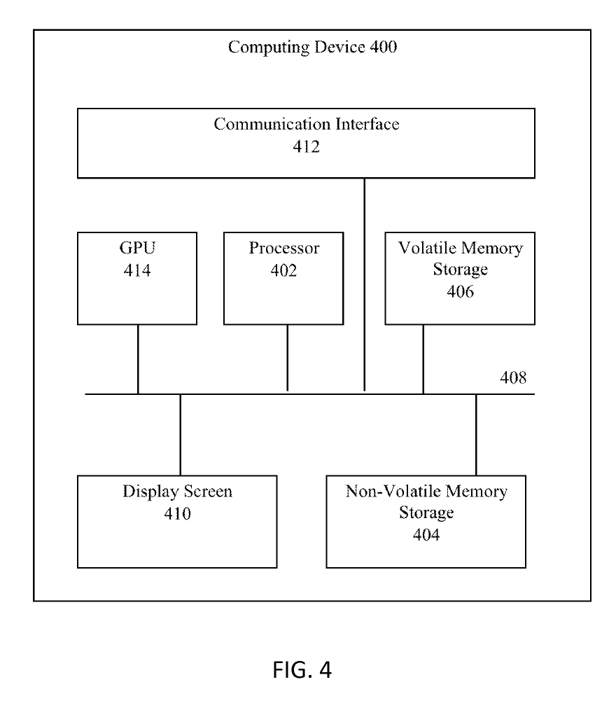

FIG. 4 is an example computer system 400 in which implementations of the present invention, or portions thereof, may be implemented as computer-readable code. For example, the components of system 106 etc., may be implemented in one or more computer systems 400 using hardware, software implemented with hardware, firmware, tangible computer-readable media having instructions stored thereon, or a combination thereof and may be implemented in one or more computer systems or other processing systems. Components in FIGS. 1-3 may be embodied in any combination of hardware and software.

Computing devices, such as a mobile device may include one or more processors 402, one or more non-volatile storage mediums 404, one or more memory devices 406, a communication infrastructure 408, a display screen 410 and a communication interface 412. Display screen 410 may be a touch screen.

Processors 402 may include any conventional or special purpose processor, including, but not limited to, digital signal processor (DSP), field programmable gate array (FPGA), application specific integrated circuit (ASIC), and multi-core processors.

GPU 414 is a specialized processor that executes instructions and programs, selected for complex graphics and mathematical operations, in parallel.

Non-volatile storage 404 may include one or more of a hard disk drive, flash memory, and like devices that may store computer program instructions and data on computer-readable media. One or more of non-volatile storage device 404 may be a removable storage device.

Memory devices 406 may include one or more volatile memory devices such as but not limited to, random access memory. Communication infrastructure 408 may include one or more device interconnection buses such as Ethernet, Peripheral Component Interconnect (PCI), and the like.

Typically, computer instructions are executed using one or more processors 402 and can be stored in non-volatile storage medium 404 or memory devices 406.

Display screen 410 allows results of the computer operations to be displayed to a user or an application developer.

Communication interface 412 allows software and data to be transferred between computer system 400 and external devices. Communication interface 412 may include a modem, a network interface (such as an Ethernet card), a communications port, a PCMCIA slot and card, or the like. Software and data transferred via communication interface 412 may be in the form of signals, which may be electronic, electromagnetic, optical, or other signals capable of being received by communication interface 412. These signals may be provided to communication interface 412 via a communications path. The communications path carries signals and may be implemented using wire or cable, fiber optics, a phone line, a cellular phone link, an RF link or other communications channels.

Some implementations may be directed to computer program products comprising software stored on any computer-useable medium. Such software, when executed in one or more data processing device, causes a data processing device(s) to operate as described herein. Some implementations may employ any computer-useable or readable medium. Examples of computer-useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

The foregoing description of the specific implementations will so fully reveal the general nature of the invention that others can, by applying knowledge within the skill of the art, readily modify and/or adapt for various applications such specific implementations, without undue experimentation, without departing from the general concept of the present invention. Therefore, such adaptations and modifications are intended to be within the meaning and range of equivalents of the disclosed implementations, based on the teaching and guidance presented herein.

The breadth and scope of the present invention should not be limited by any of the above-described exemplary implementations or any actual software code with the specialized control of hardware to implement such implementations, but should be defined only in accordance with the following claims and their equivalents.

What is claimed is:

1. A computer-implemented method, comprising:
receiving an indication that each of a plurality of areas in a construction project are ready for one or more inspections by an inspector, wherein each area is associated with a subcontractor that has performed construction work on the area;
for each of the plurality of areas, receiving, from an inspector that inspected the respective area, an inspection status associated with each inspection, wherein the inspection status identifies whether there were deficiencies associated with the area;
for each subcontractor, calculating an inspection success rate based on the inspection status of each of the areas the respective subcontractor worked on;
comparing the inspection success rate of each subcontractor to a predetermined benchmark;
determining that the inspection success rate does not meet the predetermined benchmark; and
providing for display an alert indicating that the inspection success rate of the respective subcontractor does not meet the predetermined benchmark.

2. The method of claim 1, further comprising:
receiving the predetermined benchmark from the contractor associated with the project.

3. The method of claim 1, wherein calculating an inspection success rate based on the inspection status of each of the areas the respective subcontractor worked on further comprises:
calculating a number of inspection statuses that were associated with zero deficiencies;
calculating a number of inspection statuses that were associated with one or more deficiencies; and
calculating the inspection success rate based on the number of inspection statuses that were associated with zero deficiencies and the number of inspection statuses that were associated with one or more deficiencies.

4. The method of claim 1, wherein a deficiency indicates a portion of the area does not meet building code standards.

5. The method of claim 1, further comprising:
modeling a behavior of the subcontractor based on the inspection success rate and one or more past inspection success rates.

6. The method of claim 5, further comprising:
comparing a behavior of the subcontractor to past behavior of the subcontractor;
determining a behavior alert based on the behavior comparison; and
providing the behavior alert for display.

7. The method of claim 1, further comprising:
normalizing the predetermined benchmark based on a subcontractor type.

8. The method of claim 7, further comprising:
determining the predetermined benchmark based on the subcontractor type, a combined area of one or more past inspections and a duration of one or more past inspections.

9. The method of claim 1, further comprising:
normalizing the predetermined benchmark based on project type.

10. The method of claim 1, further comprising:
normalizing the predetermined benchmark based on inspection type.

11. The method of claim 1, further comprising:
normalizing the predetermined benchmark based on area type.

12. A computer-implemented method, comprising:
receiving an indication that each of a plurality of areas in a construction project are ready for one or more inspections by an inspector, wherein each area is associated with one or more subcontractors that has performed construction work on the area;
for each of the plurality of areas, receiving, from the inspector that inspected the respective area, an inspection status associated with each inspection, wherein the inspection status identifies whether there were deficiencies associated with the area, wherein if an area is associated with one or more deficiencies, the area is associated with the subcontractor until it is ready for inspection again;
calculating an inspection duration for each inspection, wherein the inspection duration is a length of time from when the area inspection is first requested to when the area is associated with an inspection status indication indicating a closed status; and
providing an alert indicating that the inspection duration of the respective inspection exceeds an inspection duration benchmark.

13. The method of claim 12, further comprising modeling a behavior of the subcontractor based on the inspection duration and one or more past inspection durations.

14. The method of claim 12, wherein calculating includes calculating an inspection duration based on inspection request duration and subcontractor correction duration.

15. An apparatus comprising: one or more computer-readable storage media; and software embodied in the one or more computer-readable storage media that is operable when executed to:
receive an indication that each of a plurality of areas in a construction project are ready for one or more inspections by an inspector, wherein each area is associated with a subcontractor that has performed construction work on the area;
for each of the plurality of areas, receive, from an inspector that inspected the respective area, an inspection status associated with each inspection, wherein the inspection status identifies whether there were deficiencies associated with the area;
for each subcontractor, calculate an inspection success rate based on the inspection status of each of the areas the respective subcontractor worked on;
compare the inspection success rate of each subcontractor to a predetermined benchmark;
determine that the inspection success rate does not meet the predetermined benchmark; and
provide an alert indicating that the inspection success rate of the respective subcontractor does not meet the predetermined benchmark.

16. The apparatus of claim 15, wherein the computer-readable storage medium is further operable, when executed to:
receive the predetermined benchmark from the contractor associated with the project.

17. The apparatus of claim 15, wherein the computer-readable storage medium is further operable, when executed to:
calculate a number of inspection statuses that were associated with zero deficiencies;
calculate a number of inspection statuses that were associated with one or more deficiencies; and
calculate the inspection success rate based on the number of inspection statuses that were associated with zero deficiencies and the number of inspection statuses that were associated with one or more deficiencies.

18. The apparatus of claim 15, wherein a deficiency indicates a portion of the area does not meet building code standards.

19. A computer-readable medium with computer-executable instructions stored thereon and executable by a processing system and operable to cause the processing system upon such execution to perform operations comprising:
receiving an indication that each of a plurality of areas in a construction project are ready for one or more inspections by an inspector, wherein each area is associated with a subcontractor that has performed construction work on the area;
for each of the plurality of areas, receiving, from an inspector that inspected the respective area, an inspection status associated with each inspection, wherein the inspection status identifies whether there were deficiencies associated with the area;
for each subcontractor, calculating an inspection success rate based on the inspection status of each of the areas the respective subcontractor worked on;
comparing the inspection success rate of each subcontractor to a predetermined benchmark;
determining that the inspection success rate does not meet the predetermined benchmark; and
providing an alert indicating that the inspection success rate of the respective subcontractor does not meet the predetermined benchmark.

20. The computer-readable medium of claim 19, wherein the operations further comprise:
receiving the predetermined benchmark from the contractor associated with the project.
